(19) United States
(12) Patent Application Publication
(10) Pub. No.: US 2017/0278483 A1
(43) Pub. Date: Sep. 28, 2017

(54) IMAGE DISPLAY DEVICE

(71) Applicant: Sharp Kabushiki Kaisha, Osaka (JP)

(72) Inventors: Jin MIYAZAWA, Osaka (JP); Kazuo NAKAMURA, Osaka (JP); Noriyuki TANAKA, Osaka (JP)

(73) Assignee: Sharp Kabushiki Kaisha, Osaka (JP)

(21) Appl. No.: 15/505,372

(22) PCT Filed: Aug. 24, 2015
(86) PCT No.: PCT/JP2015/004232

§ 371 Date: Feb. 21, 2017

(30) Foreign Application Priority Data
Aug. 25, 2014 (JP) 2014-170324

(51) Int. Cl. G09G 5/10; G06F 3/041; G06F 3/16; G09G 3/36

(52) U.S. Cl. CPC G09G 5/10; G09G 3/3607; G06F 3/041; G06F 3/167; G09G 2320/0673; G09G 2320/068; G09G 2310/08; G09G 2354/00

(57) ABSTRACT

An object of the present invention is to provide an image display device that can determine the viewing direction of the user on the basis of user operations such as touch input, and perform gamma correction according to the viewing direction. The image display device includes: a display panel; a first touch detection part that detects a first input operation for any one of a plurality of touch detection regions provided in respective directions of the display panel; a direction determination part that determines directions corresponding to positions where the touch detection regions are provided on the basis of the first input operation; an angle data storage part that stores first angle data defined for each viewing direction of the image display device; and a gamma correction part that applies a first gamma correction value for an image displayed in the display panel on the basis of the direction and the first angle data.

### TECHNICAL FIELD

The present invention relates to an image display device, and in particular, relates to an image display device that performs appropriate gamma correction according to the viewing direction and the viewing angle with respect to a display panel.

### BACKGROUND ART

In recent years, as a result of an increase in size and reduction in profile of liquid crystal display (LCD) devices, LCD panels are widely used in image display devices (or monitors) included in televisions, mobile phones, and car navigation devices.

In general, image display devices including CRT display devices, liquid crystal display devices, or the like having unique gamma characteristics (also referred to as gradation characteristics). Gamma characteristics refer to characteristics in which the input/output relationship is not directly proportional (linear) but is logarithmic (gamma), such as light output characteristics of the image display device with respect to signal strength of the inputted image data. Such gamma characteristics can be represented by formula 1.

output luminance (y)=input gradation (x) ̂γ(gamma value of image display device) Formula 1

If the gamma value of the image display device is constant (for example, γ=2.2), then the gamma characteristics of the image display device form a curve in the form of an exponential function.

In such an image display device, the gamma characteristics are not linear. Thus, when displaying high resolution image data on an image display device, adjustments such as gamma correction (gradation correction) need to be performed on the image display device according to the image being displayed (according to the RGB colors, for example). In particular, as shown in FIGS. 16A and 16B, LCD panels and the like have a problem that gamma characteristics differ depending on the viewing angle and viewing direction of the user with respect to the image display device.

FIG. 16A shows an example of a gamma characteristic curve for when the image display device is viewed from above. FIG. 16B shows an example of a gamma characteristic curve for when the image display device is viewed from the right. In general, the change in gamma characteristic values when the image display device is viewed from above or below is greater than the change in gamma characteristic values when the image display device is viewed from the right or the left. Various countermeasures have been studied for conventional devices in consideration of such properties of gamma characteristics.

### RELATED ART DOCUMENTS

### Patent Documents

Patent Document 1: Japanese Patent Application Laid-Open Publication No. 2013-236351

Patent Document 2: Japanese Patent Application Laid-Open Publication No. 2010-044179

Patent Document 3: Japanese Patent Application Laid-Open Publication No. 2009-128381

Patent Document 4: Japanese Patent Application Laid-Open Publication No. 2007-212664

Patent Document 5: WO 2013/008282

Patent Document 1 discloses an image processing device including a camera. The image processing device acquires facial images of N (N being greater than or equal to 1) viewers, calculates the viewing angle and rotational angle for each of the N viewers according to the facial images, and then performs gradation correction on the basis of the viewing angles and rotational angles. The gradation correction is performed on the basis of the gradation correction data stored in advance in the image processing device (correction information corresponding to each viewing angle and rotational angle).

Patent Document 2 discloses a liquid crystal display device including a gamma correction table corresponding to each viewing angle from the top, bottom, left, and right (additionally, may have a table for each of the RGB colors). The liquid crystal display device acquires an attachment angle θ1 for the device display using an acceleration sensor, calculates an offset angle θ2 from position information with respect to the θ1 inputted by the user, and calculates the viewing angle θ of the user. Gamma correction is performed on the basis of the viewing angle θ.

Patent Documents 3, 4, and 5 all disclose inventions that include gamma correction data (LUT) or the like corresponding to each of the viewing angles, and that capture an image of a subject using an imaging part such as a camera, calculate the viewing angle of the subject according to the captured image, and perform gamma correction (chroma correction) on the basis of the viewing angle.

### SUMMARY OF THE INVENTION

### Problems to be Solved by the Invention

However, all of the inventions disclosed in Patent Documents 1 to 5 involve imaging a user (subject) using a camera, calculating the viewing angle of the user by the captured image, and performing gamma correction on the basis of the calculated viewing angle. This method presents the following problem.

If, for example, the camera cannot take a high resolution image of the user (characteristics of the user, for example) for reasons such as the user being in a dark room, it is not possible to calculate with a high degree of accuracy the viewing angle of the user by the above method. Thus, it is not possible to display an image with the optimal luminance based on the viewing angle. In particular, if the invention disclosed in Patent Documents 1 to 5 were applied to a car navigation device, if the car is being driven at night, the interior light of the car is typically turned off while driving, which makes the above problem especially noticeable.

The present invention takes into account the above problem, and an object thereof is to provide an image display device that can determine the viewing direction of the user on the basis of user operations such as touch input, and perform gamma correction according to the viewing direction.

### Means for Solving the Problems

In order to solve the above-mentioned problem, a first aspect of an image display device according to the present invention includes: a display panel; a first touch detection part detecting a first input operation on any one of a plurality of touch detection regions provided in each direction of the display panel; a direction determination part determining, in accordance with the detected first input operation, directions corresponding to positions where the plurality of touch detection regions are provided; and an angle data storage part storing a first angle data defined for each viewing direction of the image display device; and a gamma correction part applying, in accordance with the determined direction and the stored first angle data, a first gamma correction value to an image displayed on the display panel.

A second aspect of an image display device according to the present invention is the first aspect of the image display device according to the present invention, further including: an image display part displaying an input interface on the display panel; and an angle conversion part calculating second angle data in accordance with a second input operation inputted via the input interface, wherein the gamma correction part applies, in accordance with the calculated second angle data, a second gamma correction value to the image to which the first gamma correction value has been applied.

A third aspect of an image display device according to the present invention is the second aspect of the image display device according to the present invention, wherein the angle conversion part stores the calculated second angle data as the first angle data in the angle data storage part.

A fourth aspect of an image display device according to the present invention is the second or third aspect of the image display device according to the present invention, wherein the gamma correction part applies the first gamma correction value and the second gamma correction value according to formula 1:

output luminance=255×(input gradation/255( ) ̂(1/(γ×angle correction)) angle correction=1+N×Cos θ Formula 1,

where γ is a gamma value of the display panel, N is a correction coefficient set in advance according to the determined direction, and θ is an angle corresponding to the first angle data and the second angle data.

A fifth aspect of an image display device according to the present invention is the second to fourth aspects of the image display device according to the present invention, wherein the input interface is displayed in an orientation corresponding to the determined direction.

A sixth aspect of an image display device according to the present invention is the first to fifth aspects of the image display device according to the present invention, wherein the display panel includes a plurality of image display regions, wherein the image display device further includes: a second touch detection region detecting a third input operation; and an image region determination part determining, in accordance with the detected third input operation, whether any of the plurality of image display regions has been selected, and wherein the gamma correction part applies the first gamma correction value to the determined image display region.

A seventh aspect of an image display device according to the present invention includes: a display panel; a plurality of voice detection parts provided in each direction of the image display device, the plurality of voice detection parts detecting a voice; a direction determination part determining an arrival direction of the voice in accordance with the voice detected; an angle data storage part storing first angle data defined for each viewing direction of the image display device; and a gamma correction part applying, in accordance with the determined arrival direction and the stored first angle data, a first gamma correction value to an image displayed in the display panel.

An eighth aspect of an image display device according to the present invention is the seventh aspect of the image display device according to the present invention, further including: an image display part displaying an input interface on the display panel; and an angle conversion part calculating second angle data in accordance with a first input operation inputted via the input interface, wherein the gamma correction part applies, in accordance with the calculated second angle data, a second gamma correction value to the image to which the first gamma correction value has been applied.

A ninth aspect of an image display device according to the present invention is the eighth aspect of the image display device according to the present invention, wherein the angle conversion part stores the calculated second angle data as the first angle data in the angle data storage part.

A tenth aspect of an image display device according to the present invention is the eighth or ninth aspect of the image display device according to the present invention, wherein the gamma correction part applies the first gamma correction value and the second gamma correction value according to formula 1:

output luminance=255×(input gradation/255( ) ̂(1/(γ×angle correction)) angle correction=1+N×Cos θ Formula 2

where γ is a gamma value of the display panel, N is a correction coefficient set in advance according to the determined arrival direction, and θ is an angle corresponding to the first angle data and the second angle data.

An eleventh aspect of an image display device according to the present invention is the eighth to tenth aspects of the image display device according to the present invention, wherein the input interface is displayed in an orientation corresponding to the determined arrival direction.

A twelfth aspect of an image display device according to the present invention is the seventh to eleventh aspects of the image display device according to the present invention, wherein the display panel includes a plurality of image display regions, wherein the image display device further includes: an image region determination part determining, in accordance with a second input operation received by the image display device, whether any of the plurality of image display regions has been selected, and wherein the gamma correction part applies the first gamma correction value to the determined image display region.

A thirteenth aspect of an image display device according to the present invention includes: a display panel; a first touch detection part detecting a first input operation on any one of a plurality of touch detection regions provided in each direction of the display panel; a tilt detection part detecting a first angular speed when the image display device is rotated about an axis of centers of lengthwise direction side faces of the image display device, and detecting a second angular speed when the image display device is rotated about an axis of centers of widthwise direction side faces of the image display device; a direction/angle determination part determining, in accordance with the detected first input operation, directions corresponding to positions where the plurality of touch detection regions are provided, and determining a first angle in accordance with the detected first angular speed, and determining a second angle in accordance with the detected second angular speed; and a gamma correction part applying a first gamma correction value for an image displayed on the display panel by using the determined direction and the determined first or second angle.

A fourteenth aspect of an image display device according to the present invention is the thirteenth aspect of the image display device according to the present invention, further including: an image display part displaying an input interface on the display panel; and an angle conversion part calculating angle data in accordance with a second input operation inputted via the input interface, wherein the gamma correction part applies, in accordance with the calculated angle data, a second gamma correction value to the image to which the first gamma correction value has been applied.

A fifteenth aspect of an image display device according to the present invention is the thirteenth aspect of the image display device according to the present invention, wherein the gamma correction part selects one of the determined first angle and the determined second angle to use on the basis of the determined direction.

A sixteenth aspect of an image display device according to the present invention is the thirteenth aspect of the image display device according to the present invention, wherein the gamma correction part selects one of the determined first angle and the determined second angle to use on the basis of a value of the determined first angle and a value of the determined second angle.

A seventeenth aspect of an image display device according to the present invention is the fourteenth aspect of the image display device according to the present invention, wherein the input interface is displayed in an orientation corresponding to the determined direction.

An eighteenth aspect of an image display device according to the present invention is the thirteenth to seventeenth aspects of the image display device according to the present invention, wherein the display panel includes a plurality of image display regions, wherein the image display device further includes: a second touch detection region detecting a third input operation; and an image region determination part determining, in accordance with the detected third input operation, whether any of the plurality of image display regions has been selected, and wherein the gamma correction part applies the first gamma correction value to the determined image display region.

### Effects of the Invention

According to the image display device of the present invention, it is possible to perform optimal gamma correction according to the viewing direction of the user even in a situation in which a high resolution image of the user cannot be captured, such as when the user is in a dark room.

### BRIEF DESCRIPTION OF THE DRAWINGS

FIG. 1 is a block diagram showing an example of a configuration of an image display device according to Embodiment 1 of the present invention.

FIG. 2A shows an example of gamma correction curves according to an embodiment of the present invention.

FIG. 2B shows an example of gamma correction curves according to an embodiment of the present invention.

FIG. 3 shows an example of a usage state of the image display device according to Embodiment 1 of the present invention.

FIG. 4 is a flowchart showing an example of a process executed by the image display device according to Embodiment 1 of the present invention.

FIG. 5 shows an example of a correction value adjustment input gauge and a correction value adjustment input indicator according to an embodiment of the present invention.

FIG. 6 is a block diagram showing an example of a configuration of an image display device according to Embodiment 2 of the present invention.

FIG. 7 shows an example of a usage state of the image display device according to Embodiment 2 of the present invention.

FIG. 8 is a flowchart showing an example of a process executed by the image display device according to Embodiment 2 of the present invention.

FIG. 9 is a block diagram showing an example of a configuration of an image display device according to Embodiment 3 of the present invention.

FIG. 10 shows an example of a usage state of the image display device according to Embodiment 3 of the present invention.

FIG. 11 is a flowchart showing an example of a process executed by the image display device according to Embodiment 3 of the present invention.

FIG. 12A is an outer perspective view of the image display device according to Embodiment 3 of the present invention.

FIG. 12B is an outer perspective view of the image display device according to Embodiment 3 of the present invention.

FIG. 13 is a block diagram showing an example of a configuration of an image display device according to Embodiment 4 of the present invention.

FIG. 14 shows an example of a usage state of the image display device according to Embodiment 4 of the present invention.

FIG. 15 is a flowchart showing an example of a process executed by the image display device according to Embodiment 4 of the present invention.

FIG. 16A shows an example of gamma characteristic curves. FIG. 16B shows an example of gamma characteristic curves.

### DETAILED DESCRIPTION OF THE PREFERRED EMBODIMENTS

Embodiments 1 to 4 of the present invention will be described below with reference to the attached drawings. It is assumed that an image display device according to the present invention would be applied to an image display device having viewing angle dependency such as a liquid crystal display device.

### Embodiment 1

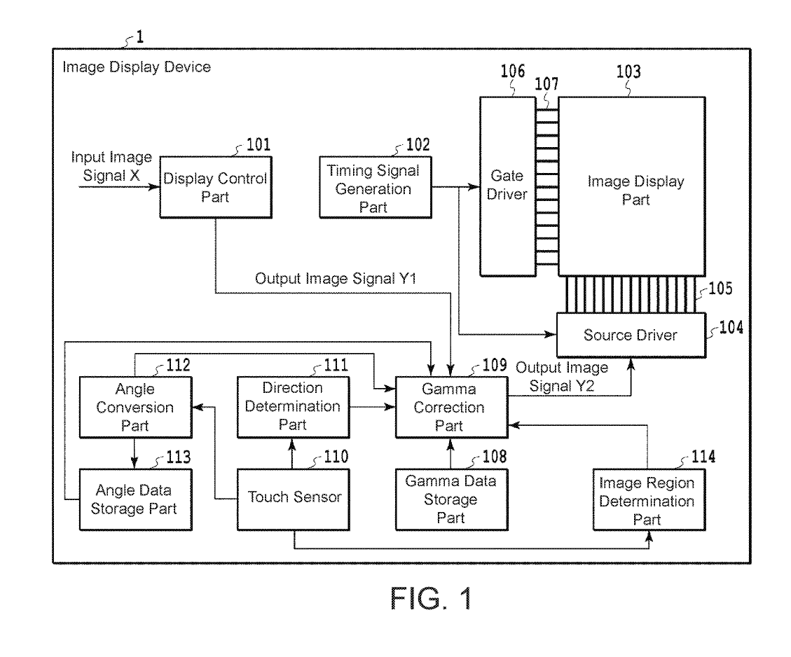

FIG. 1 is a block diagram showing an example of a configuration of an image display device according to Embodiment 1 of the present invention. An image display device 1 includes a display control part 101, a timing signal generation part 102, an image display part 103 (display panel), a source driver 104, data signal lines 105, a gate driver 106, gate signal lines 107, a gamma data storage part 108, a gamma correction part 109, a touch sensor 110, a direction determination part 111, an angle conversion part 112, an angle data storage part 113, and an image region determination part 114.

The display control part 101 performs a prescribed process on an input image signal X received from outside to convert it to an output image signal Y1, and outputs the output image signal Y1 to the gamma correction part 109.

The timing signal generation part 102 outputs to the source driver 104 timing signals such as a source clock signal and a source start pulse signal. In addition, the timing signal generation part 102 outputs to the gate driver 106 timing signals such as a gate clock signal and a gate start pulse signal.

The image display part 103 has a plurality of display elements (not shown) such as thin film transistors (TFT) arranged in a matrix at respective positions where the data signal lines 105 intersect with the gate signal lines 107. Each of the display elements is connected, respectively, to a data signal line 105 and a gate signal line 107.

The source driver 104 supplies, to each of the plurality of data signal lines 105, a voltage signal to control the light transmittance of the display elements according to the gradation of the output image signal Y2. This voltage signal is supplied on the basis of the timing signals such as the source clock signal and the source start pulse signal outputted from the timing signal generation part 102.

The gate driver 106 supplies an address signal to each of the plurality of gate signal lines 107 in order to selectively drive each display element connected to the gate signal line 107. This address signal is supplied on the basis of the timing signals such as the gate clock signal and the gate start pulse signal outputted from the timing signal generation part 102.

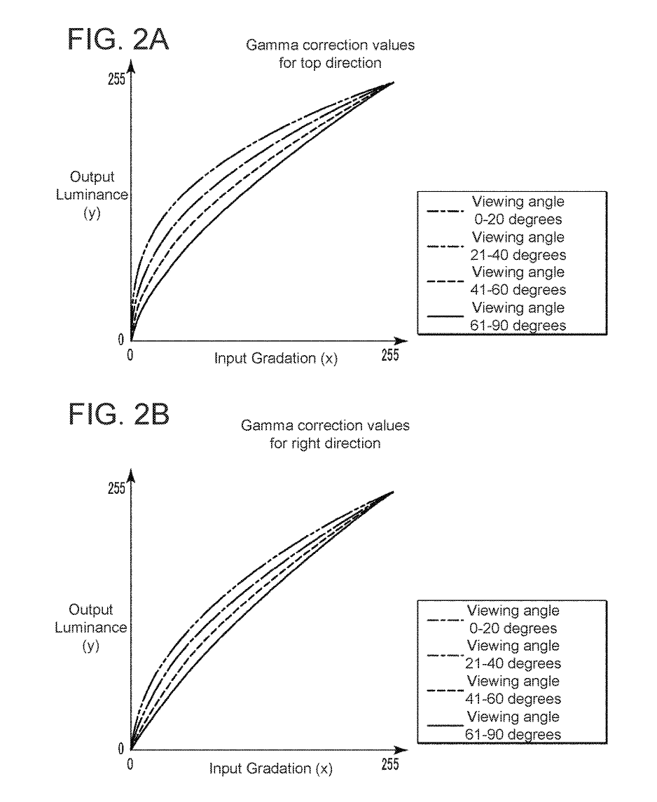

The gamma data storage part 108 stores a plurality of gamma correction tables 1, 2, . . . n. The plurality of gamma correction tables correspond to gamma characteristics defined for the direction in which vision is directed towards the image display part 103 (the up, down, left, or right direction from which the image display part 103 is viewed, for example; hereinafter, the “viewing direction”), with reference to the direction normal to the image display part 103 or the direction normal to each of a plurality of image display regions into which the image display part 103 is divided, and the viewing angle with reference to the direction normal to the image display part 103 corresponding to the viewing direction (hereinafter, the “viewing angle”). The change in gamma characteristics differs depending on the viewing direction and viewing angle with respect to the image display part 103. In order to handle this change, the present embodiment includes a gamma correction table having correction values indicated by the gamma correction curves shown in FIGS. 2A and 2B. The gamma correction table is defined for each viewing direction and viewing angle (the viewing angle may be defined in one or more degree increments). The correction values indicated in the gamma correction table can be calculated by the following formula 2 on the basis of the gamma correction values for each viewing direction and viewing angle.

output luminance (y =255×(input gradation (x)/255) ̂(1/γ(gamma value of image display device)) Formula 2

If the gamma characteristics of the image display part 103 differ depending on the RGB color, a gamma correction table may be provided for each of the RGB colors. In the present embodiment, the viewing direction and viewing angle above are defined with reference to the direction normal to the image display part 103 or the direction normal to each of the divided image display regions, but the configuration is not limited thereto. For example, the viewing direction and viewing angle may be defined with reference to a given position on a horizontal plane of the image display device 1 (this similarly applies to Embodiments 2 to 4).

The gamma correction part 109 acquires the gamma correction table from the gamma data storage part 108 on the basis of the viewing direction indicated by a direction signal outputted from the direction determination part 111, and the viewing angle stored in the angle data storage part 113 corresponding to the viewing direction (or an angle corresponding to an angle signal outputted from the angle conversion part 112). The gamma correction part 109 performs gamma correction (converts gradation values) on the output image signal Y1 outputted from the display control part 101 and converts the output image signal Y1 to an output image signal Y2, on the basis of the acquired gamma correction table. Also, instead of acquiring the gamma correction table, the gamma correction part 109 performs gamma correction by a correction value calculation formula taking as a variable the viewing angle stored in the angle data storage part 113 corresponding to the viewing direction, on the basis of the viewing direction indicated by a direction signal outputted from the direction determination part 111. The gamma correction is performed for each region of the image display part 103 indicated by coordinate signals outputted from the image region determination part 114. The output image signal Y2 is outputted to the source driver 104.

The touch sensor 110 detects prescribed input operations by the user (such as a touch operation, a tap operation, and a sliding operation, for example) by using techniques such as the resistive film mode or the capacitive mode. When a finger or the like contacts the touch sensor 110, it converts a position where the finger has contacted or a position where the finger released contact into a coordinate signal with an X axis and a Y axis, and outputs the coordinate signal to the direction determination part 111, the angle conversion part 112, and the image region determination part 114. The touch sensor 110 has a plurality of touch detection regions provided on the display screen of the image display part 103 and/or the periphery thereof.

The direction determination part 111 determines the user's viewing direction with respect to the image display part 103 on the basis of the coordinate signal outputted from the touch sensor 110 and outputs the viewing direction as a direction signal to the gamma correction part 109.

The angle conversion part 112 determines the user's viewing angle corresponding to the gamma correction variable designated by the user on the basis of the coordinate signal outputted from the touch sensor 110 and outputs the viewing angle as an angle signal to the gamma correction part 109.

The angle data storage part 113 stores the angle signal (angle data) outputted from the angle conversion part 112 for each viewing direction determined by the direction determination part 111.

The image region determination part 114 determines the image display region of the image display part 103 selected by the user on the basis of the coordinate signal outputted from the touch sensor 110. The image region determination part 114 outputs the coordinate signal corresponding to the image display region to the gamma correction part 109.

If the image display device according to the present invention is installed in a liquid crystal display device or the like, then in addition to the above elements, a backlight and a control part for driving the backlight would be provided, but descriptions thereof are omitted from the present specification because such elements are publicly known techniques to a person having ordinary skill in the art.

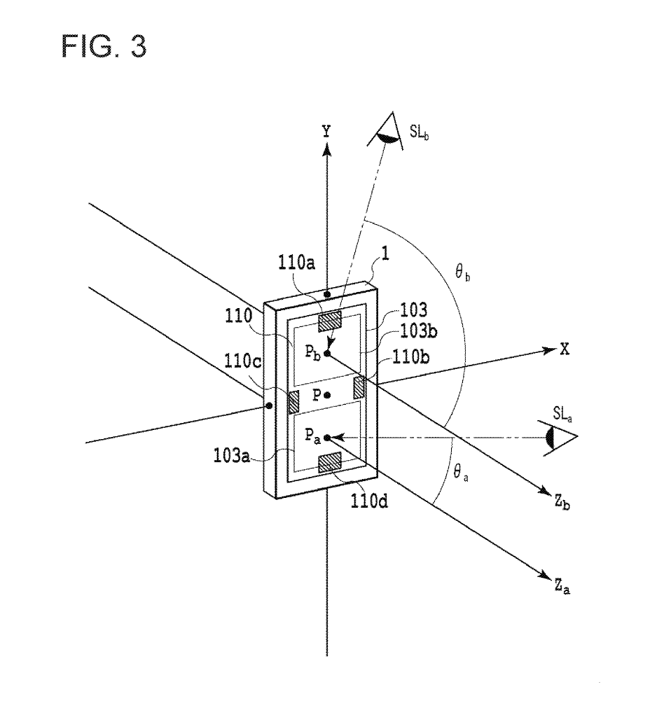

Next, an example of a usage state of the image display device according to Embodiment 1 of the present invention will be described with reference to FIG. 3. The image display device according to Embodiment 1 of the present invention is assumed to be primarily installed in mobile terminals including smartphones and tablets, as well as car navigation devices, but is not limited thereto. FIG. 3 shows an example in which the image display device 1 is installed in a mobile terminal, where users A and B both view the separate image display regions of the image display part 103.

As shown in FIG. 3, the image display device 1 includes an image display part 103 and a touch sensor 110. The touch sensor 110 includes touch detection regions 110a, 110b, 110c, and 110d in four locations at the top, bottom, left, and right of the image display part 103 and/or four locations at the top, bottom, left, and right of the periphery of the image display part 103. In the present embodiment, four sensors are provided respectively for the four directions of top, bottom, left, and right, but a number of touch detection regions corresponding to a plurality of directions such as eight directions (top, bottom, left, right, top left, bottom left, top right, bottom right) or 16 directions (top, bottom, left, right, top left, bottom left, top right, bottom right, top top right, top right right, bottom bottom right, bottom right right, top top left, top left left, bottom bottom left, bottom left left) may be provided.

The image display part 103 includes a plurality of separate image display regions 103a and 103b. A point Pₐ is located in the center of the image display region 103a, and the visual line of the user A towards the point Pₐ is designated as the visual line SLₐ. A point P_{b} is located in the center of the image display region 103b, and the visual line of the user B towards the point P_{b} is designated as the visual line SL_{b}. A point P is located at the center of the image display part 103. An axis parallel to the widthwise direction of the image display part 103 and passing through the point P is the X axis. An axis parallel to the lengthwise direction of the image display part 103 and passing through the point P is the Y axis. The line normal to the point Pₐ is the Zₐ axis, and the line normal to the point P_{b} is the Z_{b} axis.

As shown in FIG. 3, the visual line SLₐ passes from the right of the image display part 103 in the X axis direction. Thus, the viewing angle of the visual line SLₐ is represented by a viewing angle θₐ formed between the Zₐ axis and the direction of the viewing line SLₐ on the X axis. The visual line SL_{b} passes from the top of the image display part 103 in the Y axis direction. Thus, the viewing angle of the visual line SL_{b} is represented by a viewing angle θ_{b} formed between the Z_{b} axis and the direction of the viewing line SL_{b} on the Y axis.

In this state, the user A performs a prescribed input operation such as a touch operation or a tap operation on the image display region 103a. In addition, the user A performs a similar input operation in the touch detection region 110b. The reason that the input operation is performed in the image display region 103a among the separate image display regions 103a and 103b is that the visual line SLₐ of the user A is towards the image display region 103a. The reason that the input operation is performed in the touch detection region 110b among the four touch detection regions 110a to 110b is that the visual line SLₐ is towards the right in the X axis direction and the touch detection region 110b is provided in a position corresponding to this direction.

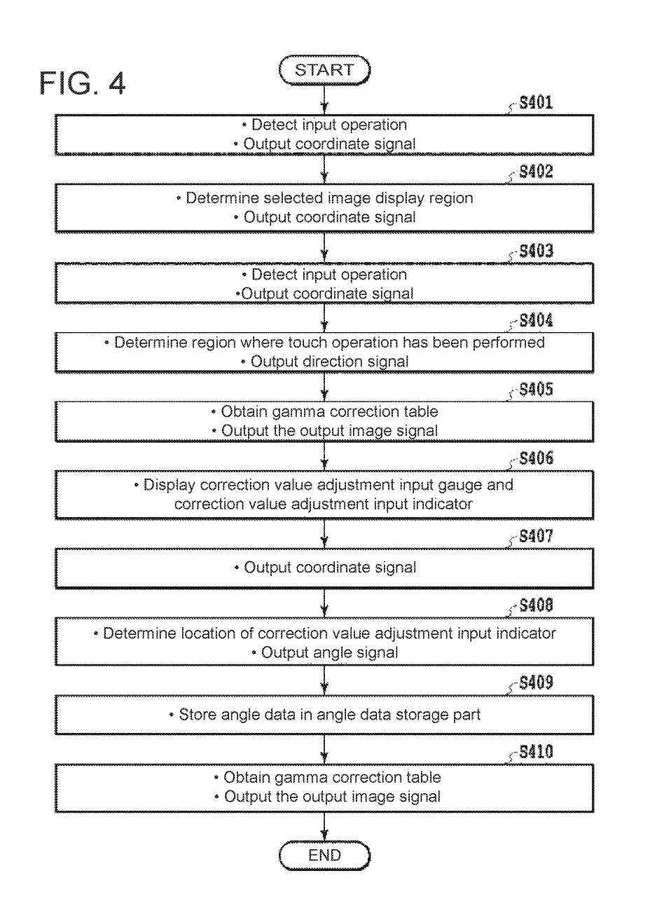

Next, an example of a process executed by the image display device according to Embodiment 1 of the present invention will be described with reference to FIG. 4. In the description of FIG. 4, it is assumed that the image display device is in the state shown in FIG. 3.

The touch sensor 110 detects a prescribed input operation such as by a user's finger, converts the position where the finger has come into contact into a coordinate signal with X axis and Y axis coordinates, and outputs the coordinate signal to the image region determination part 114 (step S401).

The image region determination part 114 determines whether the user has selected either of the image display regions 103a and 103b on the basis of the coordinate signal outputted in step 5401. This determination is performed by defining in advance the coordinate data (X, Y) in the respective image display regions 103a and 103b, and determining whether an input operation has been detected in the region corresponding to the defined coordinate data. The image region determination part 114 outputs the coordinate signal indicating the selected image display region to the gamma correction part 109 (step S402).

In the present embodiment, the input operation performed in the image display region is detected, but the configuration is not limited thereto. For example, a configuration may be adopted in which thumbnails corresponding to the image display regions 103a and 103b are displayed, and input operations on the thumbnails are detected, thereby determining the selection of the image display region (this similarly applies to Embodiments 2 to 4).

Next, the touch sensor 110 detects a prescribed input operation such as by a user's finger, converts the position where the finger comes into contact into a coordinate signal with an X axis and a Y axis, and outputs the coordinate signal to the direction determination part 111 (step S403).

The direction determination part 111 determines whether an input operation by the user has been performed in any of the touch detection regions 110a and 110d on the basis of the coordinate signal outputted in step S403. This determination is performed by defining in advance the coordinate data (X, Y) in the respective touch detection regions 110a to 110d, and determining whether an input operation has been detected in the region corresponding to the defined coordinate data. The direction determination part 111 outputs an indication that indicates the determination results as a direction signal to the gamma correction part 109 (step S404).

The gamma correction part 109 acquires the gamma correction table from the gamma data storage part 108 on the basis of the viewing direction indicated by the direction signal outputted from the direction determination part 111, and the angle data stored in the angle data storage part 113 for each viewing direction. If angle data for a specific direction is not stored in the angle data storage part 113 (that is, in an initial state), an arbitrary value may be stored as an initial value (for example, the viewing angle when viewed from the top being defined in advance as 15°, the viewing angle when viewed from the bottom being defined in advance as 30°, the viewing angle when viewed from the left being defined in advance as 45°, and the viewing angle when viewed from the right being defined in advance as 60°). The viewing angles defined in this manner may be set to an arbitrary value by the user for every viewing direction.

When the gamma correction part 109 acquires the gamma correction table, it performs gamma correction on the output image signal Y1 outputted from the display control part 101 for every image display region indicated by the coordinate signal outputted in step D402. The output image signal on which gamma correction was performed is outputted to the source driver 104 as the output image signal Y2 (step S405).

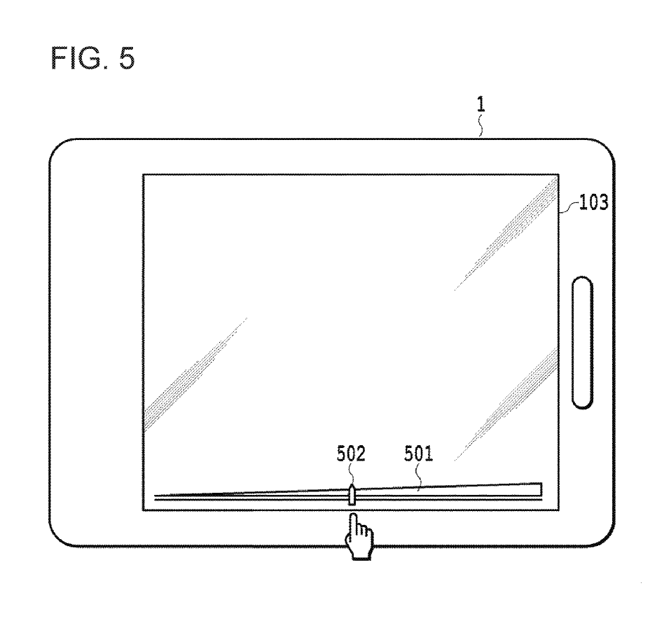

When an image corresponding to the output image signal Y2 corrected in step S405 is displayed in the image display region 103a, a correction value adjustment input gauge 501 and a correction value adjustment input indicator 502 are displayed in the image display part 103 (step S406). FIG. 5 shows the correction value adjustment input gauge 501 and the correction value adjustment input indicator 502.

As shown in FIG. 5, the correction value adjustment input gauge 501 and the correction value adjustment input indicator 502 are displayed so as to be in a positive orientation when viewing the image display part 103 from the right. In this manner, a configuration may be adopted in which the correction value adjustment input gauge 501 and the correction value adjustment input indicator 502 are displayed on the basis of the viewing direction determined by the direction determination part 111.

By adopting such a configuration, it is possible to display an input interface in an appropriate orientation for the user on the basis of the viewing direction indicated by the direction signal outputted from the direction determination part 111. With consideration for installing the image display device of the present embodiment in a non-mobile device such as a car navigation device, the correction value adjustment input gauge 501 and the correction value adjustment input indicator 502 may be displayed at a fixed orientation regardless of the determined viewing direction.

The correction value adjustment input gauge 501 and the correction value adjustment input indicator 502 are an input interface for further correcting the output luminance of the output image corrected in step 5405. When a user touches the correction value adjustment input indicator 502 and slides the correction value adjustment input indicator 502 left or right by a sliding operation, the touch sensor 110 converts the position where the user released contact after the sliding operation to a coordinate signal with X axis and Y axis coordinates, and outputs the coordinate signal to the angle conversion part 112 (step S407).

The angle conversion part 112 determines the position of the correction value adjustment input indicator 502 on the correction value adjustment input gauge 501 on the basis of the coordinate signal outputted in step S407. The angle conversion part 112 converts the value corresponding to the determined position to an angle signal and outputs the angle signal to the gamma correction part 109 (step S408). This conversion to an angle signal may be performed using a mapping table (not shown) in which the coordinate information indicated by the coordinate signal and the viewing angle are placed in correspondence with each other.

The angle conversion part 112 stores the angle signal (angle data) converted in step S408 in the angle data storage part 113 for each viewing direction determined by the direction determination part 111 in step S404 (step S409). By storing the viewing angle data corresponding to the correction value that has been corrected again by the user for each viewing direction in this manner, it is possible to maintain an optimal value for the viewing angle for each viewing direction.

The gamma correction part 109 acquires the gamma correction table on the basis of the viewing angle θ indicated by the angle signal outputted from the angle conversion part 112. When the gamma correction part 109 acquires the gamma correction table, it performs gamma correction again for every image display region indicated by the coordinate signal outputted in step S402. The output image signal on which gamma correction was performed again is outputted to the source driver 104 as the output image signal Y2 (step S410).

In steps S405 and S410, gamma correction may be performed by the following correction value calculation formula (formula 3) instead of acquiring the gamma correction table from the gamma data storage part 108.

output luminance (y)=255×(input gradation (x)/255) ̂(1/(γ(gamma value of image display device)×angle correction))

angle correction=1+N×Cos θ (N being a correction coefficient set in advance according to the direction corresponding to the direction signal outputted from the direction determination part 111) Formula 3

In other words, the gamma correction part 109 determines the value of N defined for each direction on the basis of the direction signal outputted from the direction determination part 111. The gamma correction part 109 calculates the gamma correction value using formula 3 with the viewing angle θ indicated by the angle data stored in the angle data storage part 113 or the viewing angle θ indicated by the angle signal outputted from the angle conversion part 112 as a variable.

By adopting such a configuration, appropriate gamma correction is performed with the value of N based on the direction and the value of the viewing angle θ based on the viewing angle as inputted variables, and thus, it is possible to prevent excessive expansion in the amount of data in the gamma correction table. This method of performing gamma correction by the correction value calculation formula may be adopted in Embodiments 2 to 4 to be described later.

In the present embodiment, there is also a user B viewing the image display region 103b from a direction differing from that of the user A. Thus, by the user B performing gamma correction by the above method on the image displayed in the image display region 103b, it is possible to apply a different gamma correction value on the image displayed in each image display region. In the present embodiment, an example was described in which the image display part 103 includes a plurality of image display regions, but the image display part 103 may be constituted of a single image display region. In such an example, steps S401 and S402 mentioned above would be unnecessary.

Embodiment 1 of the present invention was described above, and in Embodiment 1, it is possible to perform appropriate gamma correction even in a situation in which a high resolution image of the user cannot be captured, such as when the user is in a dark room. In particular, in mobile terminals and car navigation devices, the user often operates the device within a range where direct contact by a finger or the like is always possible, and thus, touch operation and the like is an effective input mode. Thus, by installing the image display device of the present embodiment in a mobile terminal or a car navigation device, the advantages described above are further exhibited.

The additional gamma correction is performed according to user input, and thus, the user can perform appropriate gamma correction according to the perceived luminance by the user.

Furthermore, gamma correction is performed on images of each of the image display regions, and thus, even in a situation where a plurality of users are viewing the image of the image display region from differing directions, an optimal gamma correction can be performed for each of the users.

### Embodiment 2

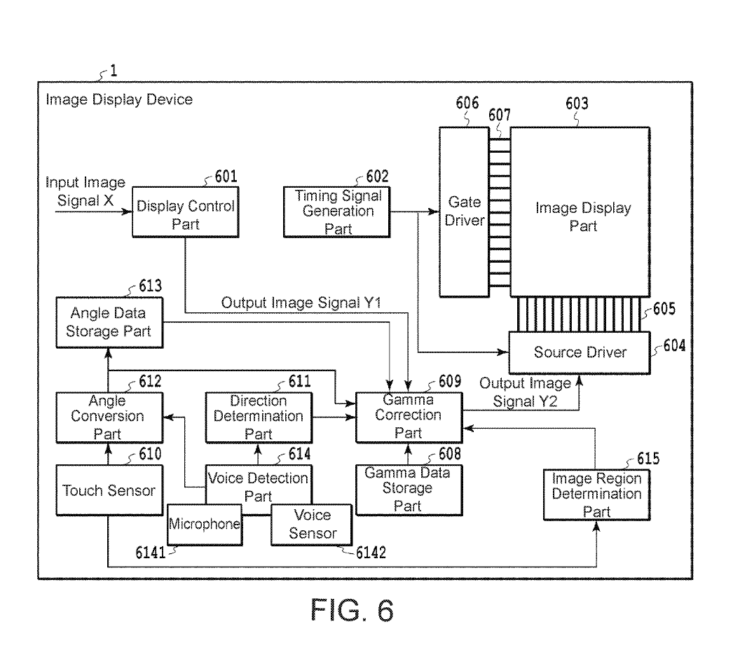

FIG. 6 is a block diagram showing an example of a configuration of an image display device according to Embodiment 2 of the present invention. An image display device 1 includes a display control part 601, a timing signal generation part 602, an image display part 603 (display panel), a source driver 604, data signal lines 605, a gate driver 606, gate signal lines 607, a gamma data storage part 608, a gamma correction part 609, a touch sensor 610, a direction determination part 611, an angle conversion part 612, an angle data storage part 613, a voice detection part 614, and an image region determination part 615.

The display control part 601, the timing signal generation part 602, the image display part 603, the source driver 604, the data signal lines 605, the gate driver 606, the gate signal lines 607, the gamma data storage part 608, the gamma correction part 609, the touch sensor 610, the angle conversion part 612, the angle data storage part 613, and the image region determination part 615 are the same as those described in FIG. 1, and thus, descriptions thereof are omitted.

The direction determination part 611 determines the user's viewing direction with respect to the image display part 603 on the basis of an arrival time or voltage value of a voice signal outputted from the voice detection part 614 and outputs the viewing direction as a direction signal to the gamma correction part 609.

The voice detection part 614 includes a microphone 6141 that receives sound waves emitted by the user, and a voice sensor 6142 that detects the sound waves and converts them to a voice signal. The voice sensor 6142 converts the sound waves received from the microphone 6141 to a voice signal and outputs the voice signal to the direction determination part 611.

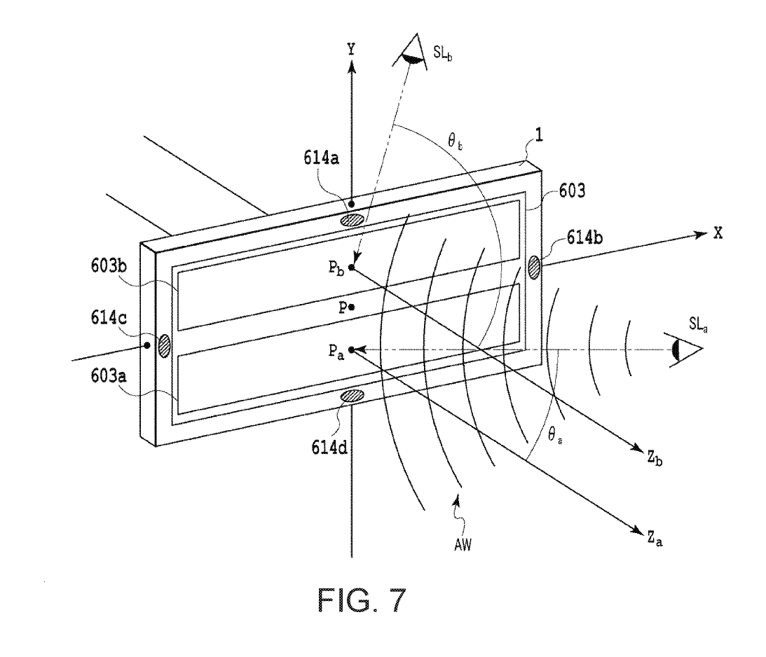

Next, an example of a usage state of the image display device according to Embodiment 2 of the present invention will be described with reference to FIG. 7. The image display device according to Embodiment 2 of the present invention is assumed to be primarily installed in mobile terminals including smartphones and tablets, car navigation devices, and televisions, but is not limited thereto. FIG. 7 shows an example in which the image display device 1 is installed in a car navigation device, where users A and B both view the separate image display regions of the image display part 103.

As shown in FIG. 7, the image display device 1 includes voice detection parts 614a, 614b, 614c, and 614d in four locations at the top, bottom, left, and right of the periphery of the image display part 603. In the present embodiment, four voice detection parts are provided respectively for the four directions of top, bottom, left, and right, but a number of voice detection parts corresponding to a plurality of directions such as eight directions or 16 directions may be provided. By providing at least three voice detection parts so as to form an isosceles triangle (in three locations of bottom right, bottom left, and top center, for example) or an inverted isosceles triangle (in three locations of top right, top left, and bottom center, for example) from the center of the image display part 603 so as to detect the sound waves to be described later, it is possible to determine the viewing direction of the user.

The image display part 603 includes a plurality of separate image display regions 603a and 603b. A point Pₐ is located in the center of the image display region 603a, and the visual line of the user A towards the point Pₐ is designated as the visual line SLₐ. A point P_{b} is located in the center of the image display region 603b, and the visual line of the user B towards the point P_{b} is designated as the visual line SL_{b}. A point P is located in the center of the image display part 603, and an axis parallel to the widthwise direction of the image display part 603 and passing through the point P is the X axis. An axis parallel to the lengthwise direction of the image display part 603 and passing through the point P is the Y axis. The line normal to the point Pₐ is the Zₐ axis, and the line normal to the point P_{b} is the Z_{b} axis.

As shown in FIG. 7, the visual line SLₐ passes from the right of the image display part 603 in the X axis direction. Thus, the viewing angle of the visual line SLₐ is represented by a viewing angle θₐ formed between the Zₐ axis and the direction of the viewing line SLₐ on the X axis. The visual line SL_{b} passes from the top of the image display part 603 in the Y axis direction. Thus, the viewing angle of the visual line SL_{b} is represented by a viewing angle θ_{b} formed between the Z_{b} axis and the direction of the viewing line SL_{b} on the Y axis.

In this state, the user A performs a prescribed input operation such as a touch operation or a tap operation on the image display region 603a. When the user A speaks towards the image display device 1, the microphones 6141a to 6141d of the four voice detection parts 614a to 614d receive a sound wave AW. The reason that the input operation is performed on the image display region 603a among the separate image display regions 603a and 603b is that the visual line SLₐ of the user A is towards the image display region 603a.

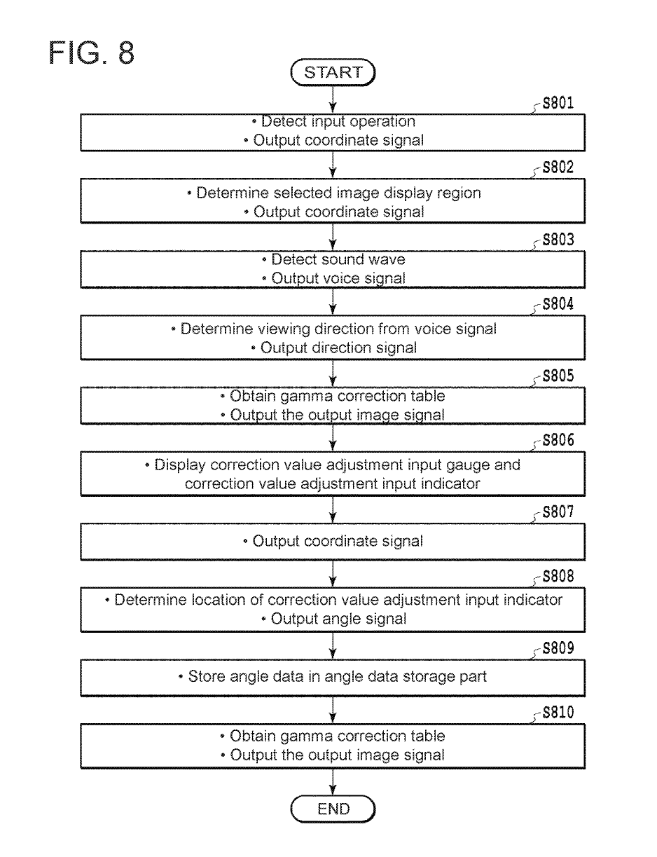

Next, an example of a process executed by the image display device according to Embodiment 2 of the present invention will be described with reference to FIG. 8. In the description of FIG. 8, it is assumed that the image display device is in the state shown in FIG. 7. Steps S801, S802, S805, S806, and S808 to S810 shown in FIG. 8 are the same as steps S401, S402, S405, S406, and S408 to S410 of FIG. 4 described in Embodiment 1, and thus, descriptions thereof are omitted here.

In step S803, the microphones 6141a to 6141d receive the sound wave AW from the user. The voice sensors 6142a to 6142d convert the sound wave AW to voice signals ASₐ to AS_{d} and output the voice signals to the direction determination part 611.

In step S804, the direction determination part 611 determines arrival times Tₐ to T_{d} of the voice signals ASₐ to AS_{d} outputted, respectively, from the voice sensors 6142a to 6142d in step S803. The direction corresponding to the voice detection part where the voice signal was detected with the earliest arrival time from among the arrival times Tₐ to T_{d} is determined to be the viewing direction of the user. A configuration may be adopted in which voltages of the detected voice signals ASₐ to AS_{d} are compared, and the direction corresponding to the position where the voice detection part with the highest detected voltage is provided is determined to be the viewing direction of the user. The direction determination part 611 outputs the above determination result as a direction signal to the gamma correction part 609.

If, as described above, the voice detection part 614 is provided in three locations (for example, a case in which the voice detection part 614a is at the top right, the voice detection part 614b is at the top left, and the voice detection part 614c is at the bottom center), then the viewing direction is determined as follows. If the voice signals ASₐ and AS_{b} outputted from the microphone 6141a of the voice detection part 614a and the microphone 6141b of the voice detection part 614b have simultaneous arrival times Tₐ and T_{b} or the difference therebetween is within a prescribed value, then it is determined that the viewing direction is from the top. If the arrival time Tₐ is earlier than the arrival time T_{b} and the difference therebetween is greater than a prescribed value, then it is determined that the viewing direction is from the right. Conversely, if T_{b} is earlier than Tₐ, then it is determined that the viewing direction is from the left. If the arrival time T_{c} of the voice signal AS_{c} outputted from the microphone 6141c of the voice detection part 614c is the earliest, then it is determined that the viewing direction is from the bottom.

In step S807, as described above, the touch sensor 610 outputs the coordinate signal to the angle conversion part 612 when the user performs a sliding operation or the like. Here, the operation by the correction value adjustment input indicator 502 may be performed by an operation by a remote controller in general use in televisions and the like (this similarly applies to the selection of the image display region in step S801). In this case, the image display device 1 includes a receiver (not shown), and the receiver receives and demodulates the signal wave emitted from the remote controller to convert the signal wave into an electrical signal, and outputs the electrical signal to the angle conversion part 612 (in step S801, the received and demodulated electrical signal is outputted to the image region determination part 615).

By adopting such a configuration, even when the image display device of the present embodiment is installed in a television or the like and the television is in a location that cannot be reached by the user's hand, appropriate gamma correction can be performed according to user instruction.

Embodiment 2 of the present invention was described above, and Embodiment 2 has similar advantages to Embodiment 1.

Installation of the present embodiment in a car navigation device is effective when the driver cannot release his/her hands from the steering wheel while driving but wishes to adjust the luminance of the image display device of the car navigation device. In other words, the present embodiment exhibits the advantage that by the driver speaking and readjustment of the image being performed by touch operation by a passenger sitting in the passenger seat of the vehicle, an additional correction can be performed by applying optimal gamma correction values as viewed from the driver's position without the driver ever releasing his/her hands from the steering wheel.

Furthermore, by installing the present embodiment in a television, the user can speak and readjustment can be performed by an operation through the remote controller. Thus, it is possible to perform an additional correction while applying optimal gamma values based on the position of a user viewing the television, which is disposed in an area where the user's hands cannot reach.

### Embodiment 3

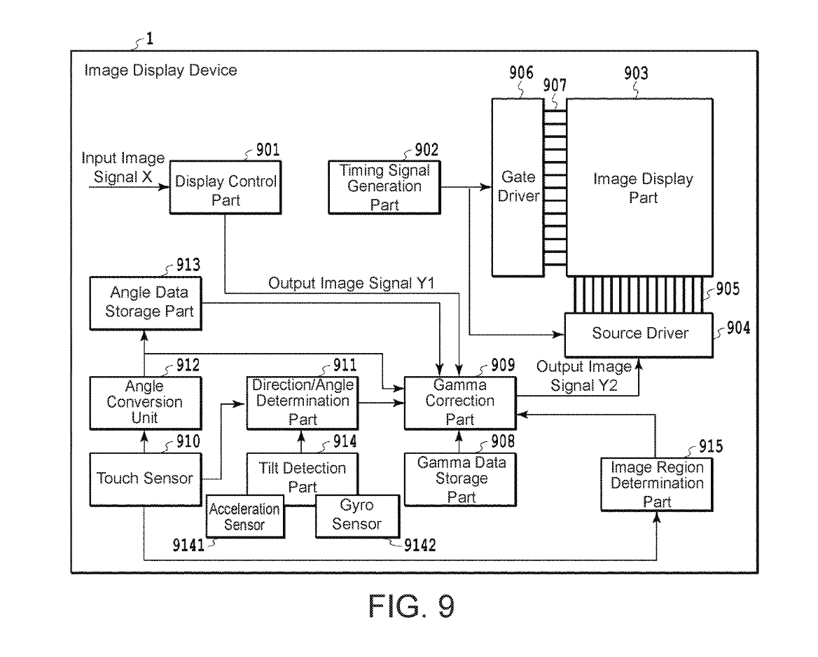

FIG. 9 is a block diagram showing an example of a configuration of an image display device according to Embodiment 3 of the present invention. An image display device 1 includes a display control part 901, a timing signal generation part 902, an image display part 903 (display panel), a source driver 904, data signal lines 905, a gate driver 906, gate signal lines 907, a gamma data storage part 908, a gamma correction part 909, a touch sensor 910, a direction/angle determination part 911, an angle conversion part 912, an angle data storage part 913, a tilt detection part 914, and an image region determination part 915.

The display control part 901, the timing signal generation part 902, the image display part 903, the source driver 904, the data signal lines 905, the gate driver 906, the gate signal lines 907, the gamma data storage part 908, the gamma correction part 909, the touch sensor 910, the angle conversion part 912, the angle data storage part 913, and the image region determination part 915 are the same as those described in FIG. 1, and thus, descriptions thereof are omitted.

The direction/angle determination part 911 determines the user's viewing direction with respect to the image display part 903 when the touch sensor 910 detects a prescribed input operation by the user and outputs the viewing direction as a direction signal to the gamma correction part 909. Also, the direction/angle determination part 911 calculates the roll and pitch on the basis of the angular speed signals indicating the angular speeds outputted from the tilt detection part 914, and outputs the roll and pitch as an angle signal to the gamma correction part 909.

The tilt detection part 914 includes an acceleration sensor 9141 and a gyro sensor 9142. The tilt detection part 914 combines these and detects the angular speed when the user tilts the image display device 1 and outputs the angular speed as an angular speed signal to the direction/angle determination part 911.

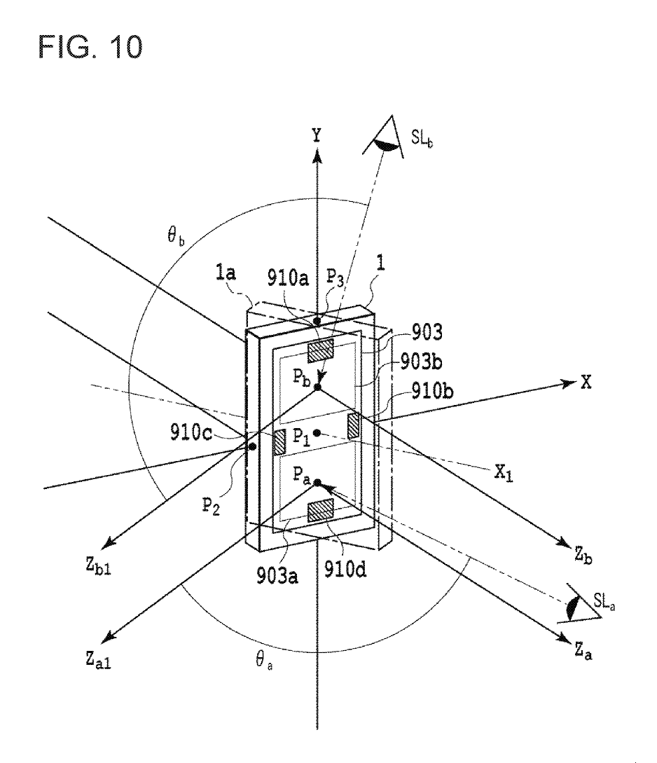

Next, an example of a usage state of the image display device according to Embodiment 3 of the present invention will be described with reference to FIG. 10. The image display device according to Embodiment 3 of the present invention is assumed to be primarily installed in mobile terminals including smartphones and tablets but is not limited thereto. FIG. 10 shows a case in which users A and B both view the separate image display regions of the image display part 903.

As shown in FIG. 10, the image display device 1 includes an image display part 903 and a touch sensor 910. The touch sensor 910 includes touch detection regions 910a, 910b, 910c, and 910d in four locations at the top, bottom, left, and right of the image display part 903 or four locations at the top, bottom, left, and right of the periphery of the image display part 903. In the present embodiment, four sensors are provided respectively for the four directions of top, bottom, left, and right, but a number of touch detection regions corresponding to a plurality of directions such as eight directions or 16 directions may be provided.

The image display part 903 includes a plurality of separate image display regions 903a and 903b. A point Pₐ is located in the center of the image display region 903a, and the visual line of the user A towards the point Pₐ is designated as the visual line SLₐ. A point P_{b} is located in the center of the image display region 903b, and the visual line of the user B towards the point P_{b} is designated as the visual line SL_{b}. A point P1 is located at the center of the image display part 903, a point P2 is located in the center of the lengthwise direction side face, and a point P3 is located in the center of the widthwise direction side face. An axis parallel to the widthwise direction of the image display part 903 and passing through the point P2 is the X axis. An axis parallel to the lengthwise direction of the image display part 903 and passing through the point P3 is the Y axis. The line normal to the point Pₐ is the Zₐ axis, and the line normal to the point P_{b} is the Z_{b} axis. With this state as the initial state, a state in which the user has rotated the image display device 1 about the Y axis is shown with the broken line la of FIG. 10. Also, the X axis, Zₐ axis, and Z_{b} axis after rotation are indicated, respectively, as X1, Zₐ₁, and Z_{b1}.

As shown in FIG. 10, the visual line SLₐ passes from the right of the image display part 903 in the X axis direction. Thus, the viewing angle of the visual line SLₐ is represented by a viewing angle θₐ formed between the Zₐ₁ axis and the direction of the viewing line SLₐ on the X axis. The visual line SL_{b} passes from the top of the image display part 903 in the Y axis direction. Thus, the viewing angle of the visual line SL_{b} is represented by a viewing angle θ_{b} formed between the Z_{bi} axis and the direction of the viewing line SL_{b} on the Y axis.

In this state, the user A performs a prescribed input operation such as a touch operation or a tap operation on the image display region 903a. Also, the user A performs a similar input operation in the touch detection region 910b. The reason that the input operation is performed in the image display region 903a among the separate image display regions 903a and 903b is that the visual line SLₐ of the user A is towards the image display region 903a. The reason that the input operation is performed in the touch detection region 910b among the four touch detection regions 910a to 910b is that the visual line SLₐ is towards the right in the X axis direction and the touch detection region 910b is provided in a position corresponding to this direction.

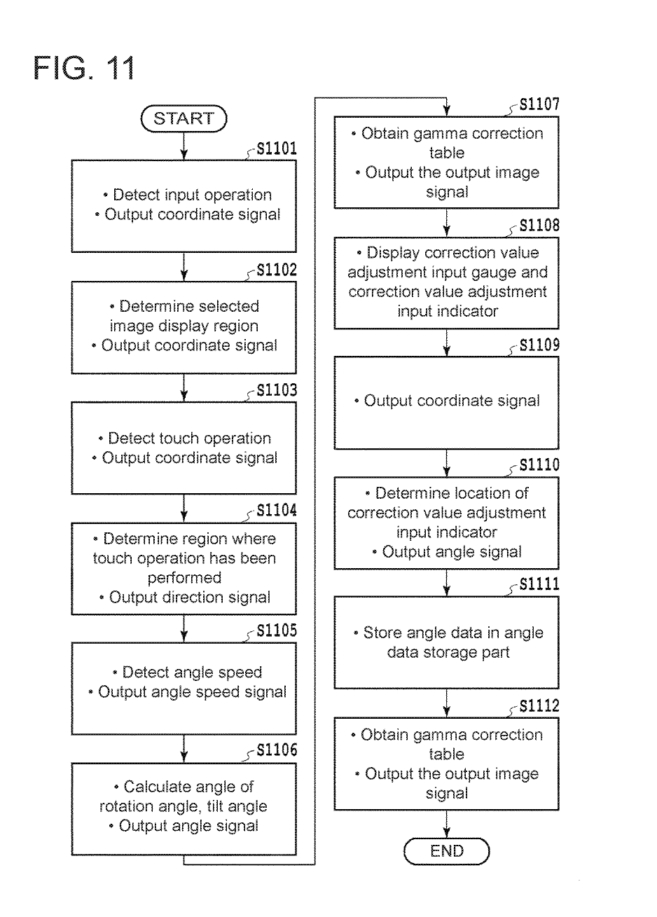

Next, an example of a process executed by the image display device according to Embodiment 3 of the present invention will be described with reference to FIG. 11. In the description of FIG. 11, it is assumed that the image display device is in the state shown in FIG. 10. Steps S1101 to S1104 and S1106 to S1112 shown in FIG. 11 are the same as steps S401 to S404 and S406 to S410 of FIG. 4 described in Embodiment 1, and thus, descriptions thereof are omitted here.

In step S1105, the tilt detection part 914 detects the angular speed ωₚ of rotation about the point P₂ of the lengthwise direction side face of the image display device 1, and the angular speed ωᵣ of rotation about the point P₃ of the widthwise direction side face, and outputs the angular speeds as angular speed signals to the direction/angle determination part 911.

In step S1106, the direction/angle determination part 911 calculates a tilt angle θₚ according to formula 4 from the angular speed ωₚ outputted from the tilt detection part 914 in step S1105. In addition, the direction/angle determination part 911 calculates a rotational angle θᵣ according to formula 5 from the angular speed ωᵣ outputted from the tilt detection part 914 in step S1105.

(Formula 1)

θₚ=∫ωₚdt Formula 4

(Formula 2)

θᵣ=∫ωᵣdt Formula 5

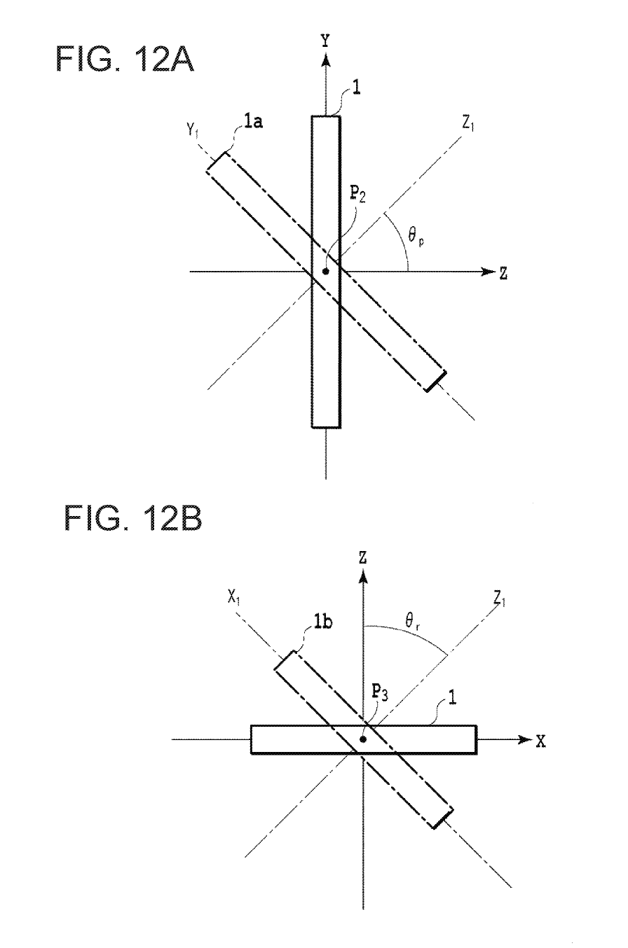

In formulae 4 and 5, t represents the time when the tilt detection part 914 detects the angular speed ωₚ and the angular speed ωᵣ. Here, the tilt angle and rotational angle for when the image display device 1 is rotated will be described with reference to FIGS. 12A and 12B.

FIG. 12A is a side view showing a case in which the image display device 1 is rotated about the point P₂ located in the center of the lengthwise direction side face, as viewed from the lengthwise direction side face of the image display device 1. An axis parallel to the lengthwise direction of the image display device 1 and passing through the point P₂ is the Y axis. The axis perpendicular to the Y axis and passing through the point P₂ is the Z axis. A state in which the image display device 1 is rotated is shown with the broken line 1a, and the Y axis and Z axis after rotation are labeled Y₁ and Z₁, respectively. The angle formed between the Z axis and the Z₁ axis is the tilt angle θₚ.

FIG. 12B is a side view showing a case in which the image display device 1 is rotated about the point P₃ located in the center of the widthwise direction side face, as viewed from the widthwise direction side face of the image display device 1. An axis parallel to the widthwise direction of the image display device 1 and passing through the point P₃ is the X axis. The axis perpendicular to the X axis and passing through the point P₃ is the Z axis. A state in which the image display device 1 is rotated is shown with the broken line 1b, and the X axis and Z axis after rotation are labeled X₁ and Z₁, respectively. The angle formed between the Z axis and the Z₁ axis is the rotational angle θᵣ.

Returning to the explanation of step S1106, when the direction/angle determination part 911 calculates the tilt angle θₚ and the rotational angle θᵣ described above, the angles are outputted as angle signals to the gamma correction part 909.

In step S1107, the gamma correction part 909 acquires the gamma correction table from the gamma data storage part 908 on the basis of the direction indicated by the direction signal outputted from the direction/angle determination part 911, and the tilt angle θₚ and the rotational angle θᵣ indicated by the angle signals outputted by the direction/angle determination part 911. If the direction signal indicates the up or down direction (vertical direction), then the gamma correction table is acquired on the basis of the tilt angle θₚ. If the direction signal indicates the left or right direction (horizontal direction), then the gamma correction table is acquired on the basis of the rotational angle θᵣ.

In this manner, it is possible to perform more appropriate gamma correction according to user designation because a determination is made for whether to use the rotational angle or the tilt angle on the basis of the direction determined according to a touch operation or the like by the user.

Even if the direction signal indicates the vertical direction, if the value of the rotational angle θᵣ is greater by a prescribed value compared to the tilt angle θₚ, then the gamma correction table may be acquired on the basis of the rotational angle θᵣ from the gamma correction table defined respectively for the horizontal direction. If the direction signal indicates the horizontal direction and the value of the tilt angle θₚ is greater by a prescribed value than the rotational angle θᵣ, then the opposite applies (similar to the method of performing gamma correction using the correction value calculation formula described in Embodiment 1, a determination of the viewing direction and viewing angle is made).

By adopting such a configuration, even if a touch operation were performed on the touch detection part 910d provided below the image display part 903, for example, then if the image display device 1 in reality is tilted to a greater degree in the horizontal direction or the like, then it is possible to apply an optimal gamma correction when viewing from the horizontal direction.

When the gamma correction part 909 acquires the gamma correction table, it performs gamma correction on the output image signal Y1 outputted from the display control part 901 and outputs the converted signal as the output image signal Y2 to the source driver 904.

Embodiment 3 of the present invention was described above, and Embodiment 3 has similar advantages to Embodiment 1, and further has the advantage of being able to perform additional correction while applying the optimal gamma correction value according to the tilt of the mobile terminal. In particular, in mobile terminals and the like, touch operations are the most effective input mode based on the form thereof, and by installing the image display device of the present embodiment in a mobile terminal, the advantages described above are further exhibited.

### Embodiment 4

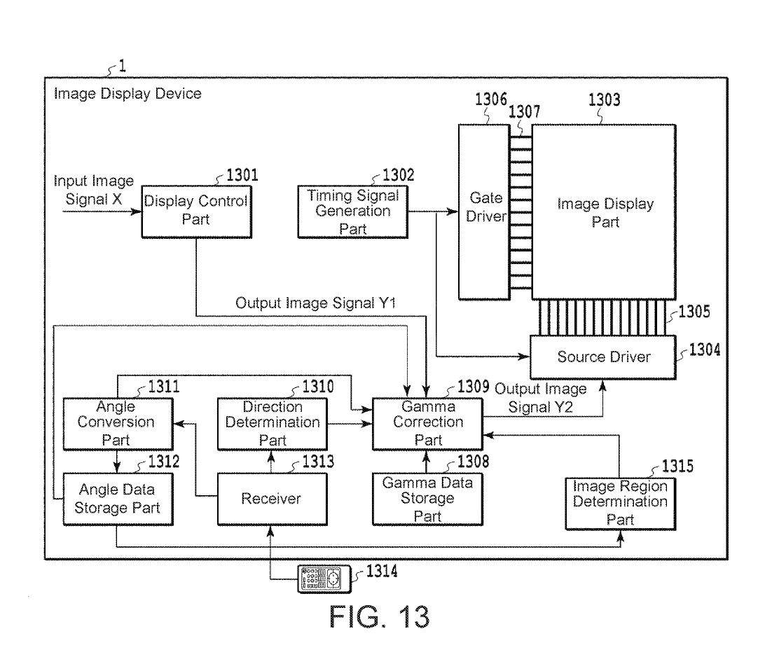

FIG. 13 is a block diagram showing an example of a configuration of an image display device according to Embodiment 4 of the present invention. An image display device 1 includes a display control part 1301, a timing signal generation part 1302, an image display part 1303 (display panel), a source driver 1304, data signal lines 1305, a gate driver 1306, gate signal lines 1307, a gamma data storage part 1308, a gamma correction part 1309, a direction determination part 1310, an angle conversion part 1311, an angle data storage part 1312, a receiver 1313, and an image region determination part 1315.

The display control part 1301, the timing signal generation part 1302, the image display part 1303, the source driver 1304, the data signal lines 1305, the gate driver 1306, the gate signal lines 1307, the gamma data storage part 1308, the gamma correction part 1309, and the angle data storage part 1312 are the same as those described in FIG. 1, and thus, descriptions thereof are omitted here.

The direction determination part 1310 determines the user's viewing direction with respect to the image display part 1303 on the basis of an arrival time of an electrical signal outputted from the receiver 1313 and outputs the viewing direction as a direction signal to the gamma correction part 1309.

The angle conversion part 1311 converts a gamma correction variable designated by the user and indicated by the electrical signal outputted from the receiver 1313 to a viewing angle and outputs the viewing angle as an angle signal to the gamma correction part 1309.

By the user performing a prescribed input operation through the remote controller 1314, the receiver 1313 receives a signal wave emitted from the remote controller 1314. The receiver 1313 demodulates the received signal wave, converts the signal wave to an electrical signal, and outputs the electrical signal to the direction determination part 1310 and the image region determination part 1315.

The image region determination part 1315 determines the image display region of the image display part 1303 selected by the user on the basis of the electrical signal outputted from the receiver 1313, and outputs a coordinate signal corresponding to the image display region to the gamma correction part 1309.

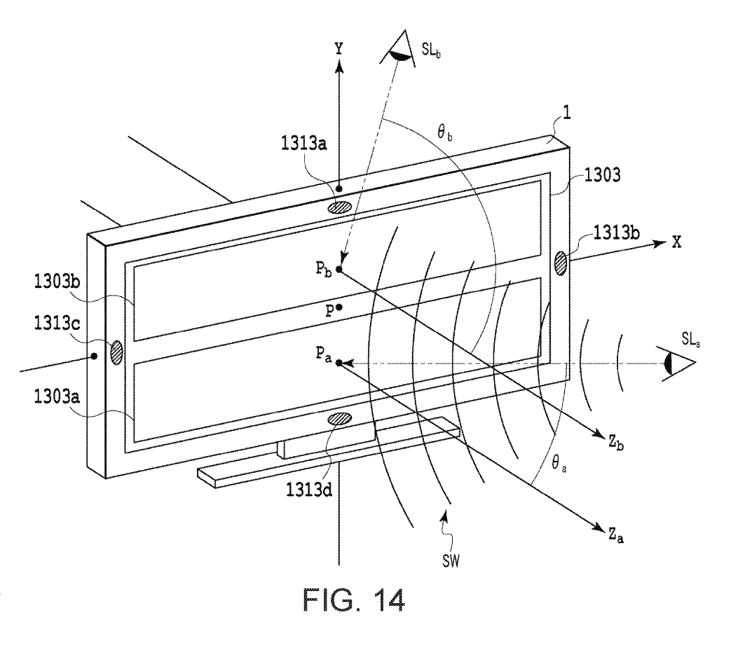

Next, an example of a usage state of the image display device according to Embodiment 4 of the present invention will be described with reference to FIG. 14. The image display device according to Embodiment 4 of the present invention is assumed to be primarily installed in televisions but is not limited thereto. FIG. 14 shows a case in which users A and B both view the separate image display regions of the image display part 1303.

As shown in FIG. 14, the image display device 1 includes receivers 1313a, 1313b, 1313c, and 1313d in four locations at the top, bottom, left, and right of the periphery thereof. In the present embodiment, four receivers are provided respectively for the four directions of top, bottom, left, and right, but a number of receivers corresponding to a plurality of directions such as eight directions or 16 directions may be provided. By providing at least three receivers so as to form an isosceles triangle (in three locations of bottom right, bottom left, and top center, for example) or an inverted isosceles triangle (in three locations of top right, top left, and bottom center, for example) from the center of the image display part 1303 so as to detect the signal waves to be described later, it is possible to determine the viewing direction of the user.

The image display part 1303 includes a plurality of separate image display regions 1303a and 1303b. A point Pₐ is located in the center of the image display region 1303a, and the visual line of the user A towards the point Pₐ is designated as the visual line SLₐ. A point P_{b} is located in the center of the image display region 1303b, and the visual line of the user B towards the point P_{b} is designated as the visual line SL_{b}. A point P is located at the center of the image display part 1303. An axis parallel to the widthwise direction of the image display part 1303 and passing through the point P is the X axis. An axis parallel to the lengthwise direction of the image display part 1303 and passing through the point P is the Y axis. The line normal to the point Pₐ is the Zₐ axis, and the line normal to the point P_{b} is the Z_{b} axis.

As shown in FIG. 14, the visual line SLₐ passes from the right of the image display part 1303 in the X axis direction. Thus, the viewing angle of the visual line SLₐ is represented by a viewing angle θₐ formed between the Zₐ axis and the direction of the viewing line SLₐ on the X axis. The visual line SL_{b} passes from the top of the image display part 1303 in the Y axis direction. Thus, the viewing angle of the visual line SL_{b} is represented by a viewing angle θ_{b} formed between the Z_{b} axis and the direction of the viewing line SL_{b} on the Y axis.

In this state, the user A causes the remote controller 1314 to emit a signal wave to indicate selection of the image display region 1303a. When the user A causes the remote controller 1314 to emit the signal wave SW towards the image display device 1, each of the four receivers 1313a to 1313d receives the signal wave SW. The reason that the image display region 1303a is selected from among the separate image display regions 1303a and 1303b is that the visual line SLₐ of the user A is towards the image display region 1303a.

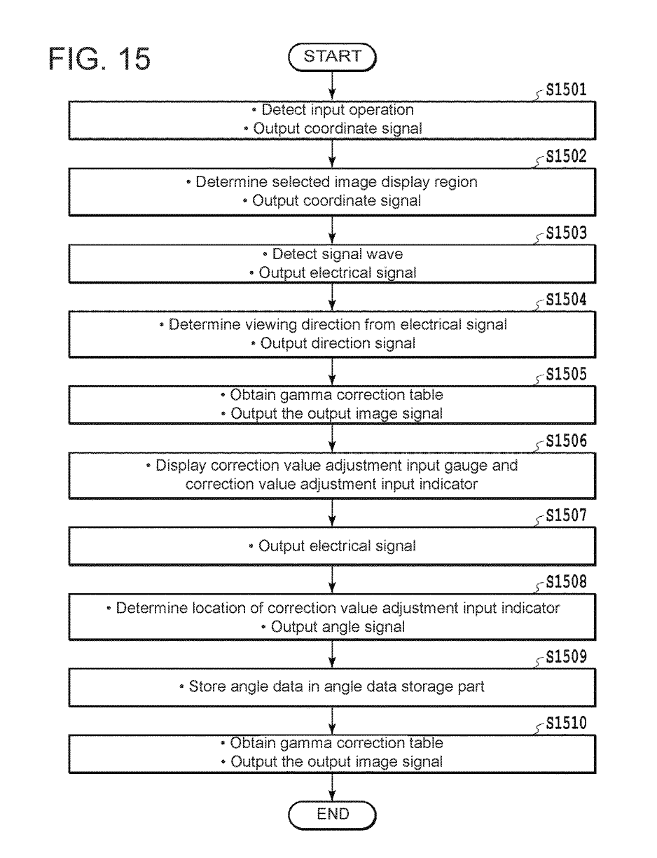

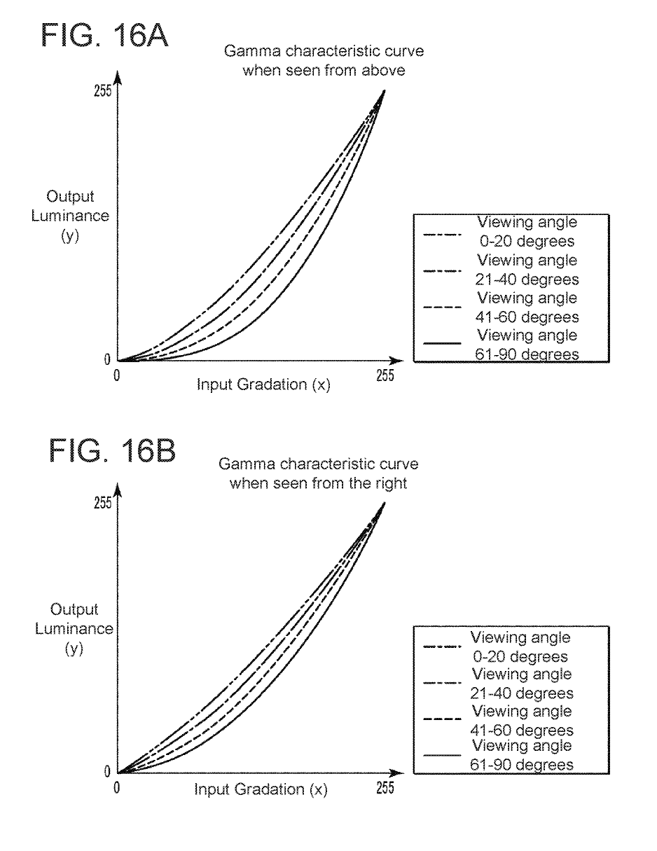

Next, an example of a process executed by the image display device according to Embodiment 4 of the present invention will be described with reference to FIG. 15. In the description of FIG. 15, it is assumed that the image display device is in the state shown in FIG. 14. Steps S1505, S1506, and S1508 to S1510 shown in FIG. 15 are the same as steps S405, S406, and S408 to S410 of FIG. 4 described in Embodiment 1, and thus, descriptions thereof are omitted here.

In step S1501, the receiver 1313 receives and demodulates a signal wave emitted by the remote controller 1314 including component values indicating that either one of the image display regions 1303a and 1303b has been selected, converts the signal wave to an electrical signal, and then outputs the electrical signal to the image region determination part 1315.

In step S1502, the image region determination part 1315 determines whether the user has selected either of the image display regions 1303a and 1303b on the basis of the electrical signal outputted in step S1501. The image region determination part 1315 outputs a coordinate signal indicating the selected image display region to the gamma correction part 1309.

In step S1503, the receivers 1313a to 1313d receive and demodulate the signal wave SW emitted by the remote controller 1314, convert the signal wave to electrical signals ESₐ to ES_{d}, and then output the electrical signals to the direction determination part 1310.

In step S1504, the direction determination part 1310 determines arrival times Tₐ to T_{d} of the electrical signals ESₐ to ES_{d} outputted, respectively, from the receivers 1313a to 1313d in step S1503. The direction corresponding to the receiver where the electrical signal was detected with the earliest arrival time from among the arrival times Tₐ to T_{d} is determined to be the viewing direction of the user. The direction determination part 1310 outputs the above determination result as a direction signal to the gamma correction part 1309.

If as described above the receiver 1313 is provided in three locations (for example, a case in which the receiver 1313a is at the top right, the receiver 1313b is at the top left, and the receiver 1313c is at the bottom center), then the viewing direction is determined as follows. If the electrical signals ESₐ and ES_{b} outputted from the receivers 1313a and 1313b have simultaneous arrival times Tₐ and T_{b} or the difference therebetween is within a prescribed value, then it is determined that the viewing direction is from the top. If the arrival time Tₐ is earlier than the arrival time T_{b} and the difference therebetween is greater than a prescribed value, then it is determined that the viewing direction is from the right. Conversely, if T_{b} is earlier than Tₐ, then it is determined that the viewing direction is from the left. If the arrival time T_{c} of the electrical signal ES_{c} outputted from the receiver 1313c is the earliest, then it is determined that the viewing direction is from the bottom.

If the signal wave SW emitted from the remote controller 1314 has a high directivity signal wave such as an infrared beam, then there are cases in which the signal wave cannot be received by all receivers 1313a to 1313d. In such a case, it is determined that the direction corresponding to the position where the receiver that has detected the signal wave SW is disposed is the viewing direction of the user.

In step S1507, when a sliding operation is performed on the correction value adjustment input indicator 502 displayed on the image display part 1303 through operation of the remote controller 1314 by the user, then the receiver 1313 receives a signal wave including component values indicating the correction value adjustment input indicator 502. The receiver 1313 demodulates the received electromagnetic wave, converts the electromagnetic wave to an electrical signal, and outputs the electrical signal to the angle conversion part 1311.

In step S1508, the angle conversion part 1311 determines the value indicated by the correction value adjustment input indicator 502 on the basis of the electrical signal outputted in step S1507. The angle conversion part 1311 converts the determined value to an angle signal corresponding to the correction value designated by the user and outputs the angle signal to the gamma correction part 1309. This conversion to an angle signal may be performed using a mapping table (not shown) in which the value indicated by the correction value adjustment input indicator 502 and the angle are placed in correspondence.

Embodiment 4 of the present invention was described above, and Embodiment 4 has similar advantages to Embodiment 1. By installing the present embodiment in a television or the like, the user can perform optimal gamma correction according to the perceived luminance by the user even when the user is in a location where he/she cannot reach the display device.

### DESCRIPTION OF REFERENCE CHARACTERS

1 image display device

1a image display device

1b image display device

103 image display part

103a image display region

103b image display region

105 data signal line

107 gate signal line

110a touch detection region

110b touch detection region

110c touch detection region

110d touch detection region

501 correction value adjustment input gauge

502 correction value adjustment input indicator

603 image display part

603a image display region

603b image display region

605 data signal line

607 gate signal line

614a voice detection part

614b voice detection part

614c voice detection part

614d voice detection part

903 image display part

903a image display region

903b image display region

905 data signal line

907 gate signal line

910a touch detection region

910b touch detection region

910c touch detection region

910d touch detection region

1305 data signal line

1307 gate signal line

1313 image display part

1303a image display region

1303b image display region

1314 remote controller

1313a receiver

1313b receiver

1313c receiver

1313d receiver

1. An image display device, comprising:
a display panel;
a touch panel coupled to the display panel, the touch panel having a plurality of touch detection regions and detecting a first input operation on any one of the plurality of touch detection regions, each touch detection region corresponding to one of prescribed general viewing directions in which a viewer views the display panel;
a direction determination part determining, in accordance with the detected first input operation, said corresponding one of the prescribed general viewing directions; and
an angle data storage part storing data specifying and associating a first viewing angle with each of the prescribed general viewing directions; and
a gamma correction part deriving, in accordance with the determined one of the general viewing directions and the stored first viewing angle associated with the determined one of the general viewing directions, a first gamma correction value, and applying the derived first gamma correction value to an image displayed on the display panel.

2. The image display device according to claim 1, further:
wherein the display panel displays the image with the first gamma correction value and an input interface so as to receive a second input operation from a viewer via the touch panel,
wherein the image display device further comprises an angle conversion part calculating second an effective viewing angle in accordance with the second input operation inputted through the touch panel via the input interface, and wherein the gamma correction part derives, in accordance with the calculated effective viewing angle, a second gamma correction value, and applies the second gamma correction value to the image to which the first gamma correction value has been applied.

3. The image display device according to claim 2,
wherein the first viewing angle stored for the associated one of the prescribed general viewing directions in the angle data storage part is updated by being replaced with said calculated effective viewing angle obtained in accordance with the second input operation, and the gamma correction part determines, in accordance with the updated first viewing angle data, the second gamma correction value.

4. The image display device according to claim 2,
wherein the gamma correction part derives each of the first gamma correction value and the second gamma correction value according to the formula: γ×(angle correction), where (angle correction)=1+N×Cos θ, γ is a prescribed default gamma value of the display panel, N is a correction coefficient set in advance for each of the plurality of general viewing directions, and 0 is an angle of the first viewing angle or the calculated effective viewing angle, thereby converting an input gradation to output luminance according to the following formula:
output luminance=(highest gradation number)×(input gradation/(highest gradation number))̂(1/(γ×angle correction)).

5. The image display device according to claim 2, wherein the input interface is displayed in an orientation corresponding to the determined one of the plurality of prescribed general viewing directions.

6. The image display device according to claim 1,
wherein the display panel includes a plurality of image display regions,
wherein the touch panel detects whether any of the plurality of image display regions has been selected by a viewer, and
wherein the gamma correction part applies the first gamma correction value to the determined image display region.

7. An image display device, comprising:
a display panel;
a plurality of signal wave receivers provided in a plurality of locations adjacent to or at a periphery of the display panel of the image display device, said plurality of signal wave receivers detecting signal waves caused to be emitted by a viewer, said signal waves being a voice uttered by a viewer or signals emitted from a remote controller held by a viewer;
a direction determination part determining that the signal waves were emitted from one of prescribed general viewing directions in accordance with the the signal waves detected by the plurality of signal wave receivers;
an angle data storage part storing data specifying and associating a first viewing angle with each of the prescribed general viewing directions; and
a gamma correction part deriving, in accordance with the determined one of the prescribed general viewing directions and the stored first viewing angle data associated with the determined one of the prescribed general viewing directions, a first gamma correction value, and applying the derived first gamma correction value to an image displayed in the display panel.

8. The image display device according to claim 7, further comprising:
a touch panel coupled to the display panel,
wherein the display panel displays the image with the first gamma correction value and an input interface so as to receive a first input operation from a viewer via the touch panel,
wherein the image display device further comprises an angle conversion part calculating an effective viewing angle in accordance with the first input operation inputted through the touch panel via the input interface, and
wherein the gamma correction part derives, in accordance with the calculated effective viewing angle, a second gamma correction value, and applies the second gamma correction value to the image to which the first gamma correction value has been applied.

9. The image display device according to claim 8, wherein the first viewing angle stored for the associated one of the prescribed general viewing directions in the angle data storage part is updated by being replaced with said calculated effective viewing angle obtained in accordance with the first input operation, and the gamma correction part determines, in accordance with the updated first viewing angle data, the second gamma correction value.

10. The image display device according to claim 8,
wherein the gamma correction part derives each of the first gamma correction value and the second gamma correction value according to the formula: γ×(angle correction), where (angle correction)=1+N×Cos θ, γ is a prescribed default gamma value of the display panel, N is a correction coefficient set in advance for each of the plurality of general viewing directions, and θ is an angle of the first viewing angle or the calculated effective viewing angle, thereby converting an input gradation to output luminance according to the following formula:
output luminance=(highest gradation number)×(input gradation/(highest gradation number))̂(1/(γ×angle correction)).

11. The image display device according to claim 8, wherein the input interface is displayed in an orientation corresponding to the determined one of the plurality of prescribed general viewing directions.

12. The image display device according to claim 7,
wherein the display panel includes a plurality of image display regions,
wherein the touch panel detects whether any of the plurality of image display regions has been selected by a viewer, and
wherein the gamma correction part applies the first gamma correction value to the determined image display region.

13. An image display device, comprising:
a display panel;
a touch panel coupled to the display panel, the touch panel having a plurality of touch detection regions and detecting a first input operation on any one of the plurality of touch detection regions, each touch detection region corresponding to one of prescribed general viewing directions in which a viewer views the display panel;
a tilt detection part detecting a first angular speed when the image display device is rotated about an axis passing through respective centers of lengthwise direction side faces of the image display device, and detecting a second angular speed when the image display device is rotated about an axis passing through respective centers of widthwise direction side faces of the image display device;
a direction/angle determination part determining, in accordance with the detected first input operation, said corresponding one of the prescribed general viewing directions, and determining a first angle in accordance with the detected first angular speed, and determining a second angle in accordance with the detected second angular speed; and
a gamma correction part deriving a first gamma correction value by using the determined one of the prescribed general viewing directions and the determined first or second angle, and applying the derived first gamma correction value to an image displayed on the display panel.

14. The image display device according to claim 13,
wherein the display panel displays the image with the first gamma correction value and an input interface so as to receive a second input operation from a viewer via the touch panel,
wherein the image display device further comprises an angle conversion part calculating an effective viewing angle in accordance with the second input operation inputted through the touch panel via the input interface, and
wherein the gamma correction part derives, in accordance with the calculated effective viewing angle, a second gamma correction value, and applies the second gamma correction value to the image to which the first gamma correction value has been applied.

15. The image display device according to claim 13, wherein the gamma correction part selects one of the determined first angle and the determined second angle to use in deriving the first gamma correction value on the basis of the determined one of the general viewing directions.

16. The image display device according to claim 13, wherein the gamma correction part selects one of the determined first angle and the determined second angle to use in deriving the first gamma correction value on the basis of a value of the determined first angle and a value of the determined second angle.

17. The image display device according to claim 14, wherein the input interface is displayed in an orientation corresponding to one of the plurality of prescribed general viewing directions from which a viewer is determined to be viewing the display panel.

18. The image display device according to claim 13,
wherein the display panel includes a plurality of image display regions,
wherein the touch panel detects whether any of the plurality of image display regions has been selected by a viewer, and wherein the gamma correction part applies the first gamma correction value to the determined image display region.

19. An image display device, comprising:
a display panel;
a plurality of signal wave receivers wave provided in a plurality of locations adjacent to or at a periphery of the display panel of the image display device, said plurality of signal wave receivers detecting signal waves emitted by a remote controller held by a viewer;
a direction determination part determining that a viewer caused the remote controller to emit the signal waves from one of prescribed general viewing directions in accordance with the signal waves detected by the plurality of signal wave receivers;
an angle data storage part storing data specifying and associating a first viewing angle with each of the prescribed general viewing directions; and
a gamma correction part deriving, in accordance with the determined one of the prescribed general viewing directions and the stored first viewing angle data associated with the determined one of the prescribed general viewing directions, a first gamma correction value, and applying the derived first gamma correction value to an image displayed in the display panel.
